(19) United States
(12) Patent Application Publication
(10) Pub. No.: US 2026/0211453 A1
(43) Pub. Date: Jul. 23, 2026

(54) VESA MOUNT DOCKING SYSTEMS FOR MOBILE DEVICES

(71) Applicant: Urban Armor Gear, LLC, Laguna Niguel, CA (US)

(72) Inventors: Carlos del Toro, Foothill Ranch, CA (US); Yu Ta Lin, Temple City, CA (US)

(21) Appl. No.: 19/451,517

(22) Filed: Jan. 16, 2026

Related U.S. Application Data
(60) Provisional application No. 63/746,663, filed on Jan. 17, 2025.

(51) Int. Cl. G06F 1/16; F16M 11/04; F16M 13/04

(52) U.S. Cl. CPC G06F 1/1632; F16M 11/041; F16M 13/04; F16M 2200/08

(57) ABSTRACT

A docking system for a mobile device includes a docking base operable to be secured to a display mount interface of a display mount. The docking base comprises a mounting post at a post offset location of the docking base. The docking system also comprises a docking adapter operable to be secured to the mobile device at a device offset location of the mobile device. The docking adapter comprises a mounting recess operable to receive the mounting post to removably secure the docking adapter to the docking base. The device offset location is offset from a center of the mobile device. The post offset location is offset from a center of the display mount interface such that the mobile device is centered about the display mount interface when the mobile device is secured to the docking adapter and the docking adapter is secured to the docking base.

### PRIORITY

This application claims priority to and the benefit of U.S. Provisional Patent Application 63/746,663, filed January 17, 2025, the entire contents of which are incorporated herein by reference.

### TECHNICAL FIELD

The present disclosure generally relates to mobile devices and, more specifically, docking systems for mobile devices.

### BACKGROUND

Early solutions for point of sale (POS) devices within a store were fixed to a countertop, often due to their size and weight or based on precedent. The advent of mobile POS software enabled mobile devices that provide much of the functionally as the fixed POS device but with more flexibility of movement throughout the store. This mobility, enabled through wireless networking and cloud-based technologies (such as digital payments and e-receipts) made these mobile devices attractive to retailers from an aesthetic standpoint by providing a “cutting edge technology” look, as well as a cost-per-POS device standpoint.

As store operators began deploying mobile POS devices, they found these devices to be able to do everything their fixed POS devices had been doing for years, so when it came time to replace the fixed POS devices, in many cases these store operators selected a mobile POS device. Some store operators also found a benefit in occasionally using a docking station to mount a mobile POS device in a fixed location, such as at a counter of a checkout lane.

Mobile devices are also employed in commercial settings, such as warehouses. In some examples, mobile devices are carried by a warehouse clerk to facilitate inventory management by scanning bar codes, entering data, viewing data, etc. The clerk may alternately work at a fixed location, such as at a desk near a loading dock, and work while carrying the mobile device with them to perform other tasks within the warehouse.

Some solutions for mounting a mobile device have included Velcro, tape, and even magnets attached to the mobile device itself or to a case that holds the mobile device. However, these solutions often lack durability for certain settings (e.g., warehouses) or are manufactured for a specific mobile device.

### SUMMARY

The appended claims define this application. The present document discloses aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for docking systems for mobile devices.

An example docking system for a mobile device disclosed herein includes a docking base and a docking adapter. The docking base is operable to be secured to a display mount interface of a display mount, the docking base comprising a mounting post at a post offset location of the docking base. The docking adapter is operable to be secured to the mobile device at a device offset location of the mobile device, the docking adapter comprising a mounting recess operable to receive the mounting post to removably secure the docking adapter to the docking base. The device offset location is offset from a center of the mobile device. The post offset location is offset from a center of the display mount interface such that the mobile device is centered about the display mount interface when the mobile device is secured to the docking adapter and the docking adapter is secured to the docking base.

An example docking system for a mobile device disclosed herein includes a docking base and a docking adapter. The docking base is operable to be secured to a display mount interface of a display mount, the docking base comprising a mounting post that is offset from a center of the display mount interface when the docking base is secured to the display mount interface. The docking adapter is operable to be secured to an oblong case that retains the mobile device, the docking adapter comprising a mounting recess operable to receive the mounting post to removably secure the docking adapter to the docking base. The docking adapter is operable to be secured offset towards a first short side of the oblong case such that the oblong case is centered about the display mount interface when the mobile device is retained in the oblong case, the oblong case is secured to the docking adapter, and the docking adapter is secured to the docking base with the mobile device in a landscape orientation.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a front perspective view of an example docking system having a docking base coupled to a display mount in accordance with one example embodiment of the present disclosure.

FIG. 2 is a front view of the docking system of FIG. 1, showing a mobile device in a case secured to the docking base in a landscape orientation.

FIG. 3 is a front view of the docking system of FIG. 1, showing the mobile device in the case secured to the docking base in a portrait orientation.

FIG. 4 is a front perspective view of the docking system of FIG. 1, showing a docking adapter before engaging the docking base.

FIG. 5 is a front perspective view of the docking system of FIG. 1, showing the docking adapter engaged with the docking base.

FIGS. 6A, 6B, and 6C are front perspective views of the docking system of FIG. 1, showing the mounting of the mobile device to the display mount.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example docking systems for mobile devices are configured to securely mount and/or couple different mobile devices to a suitable display mount. The docking systems include a docking base that is securable to the display mount and a docking adapter that is securable to a case for a mobile device. When the case and mobile device are coupled with the docking adapter, the docking adapter enables the case and mobile device to be secured to the docking base and thus to the display mount. Once secured, the docking base and the docking adapter are configured to provide data and/or electrical power to the mobile device and securely hold the mobile device to the display mount. In some embodiments, the docking adapter is securable directly to the mobile device. In some embodiments, the docking adapter is securable to any of a plurality of cases for different mobile devices. In some such embodiments, the docking system enables any of the different mobile devices to be secured to the display mount.

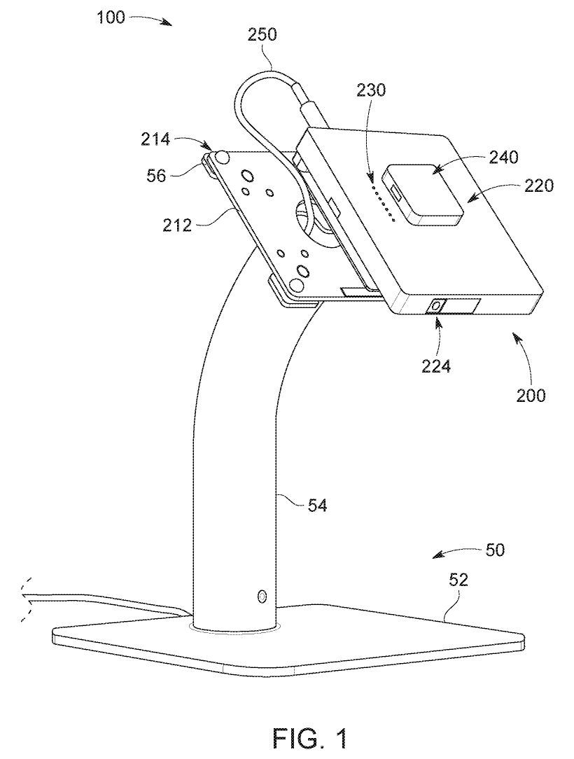

Turning to the figures, FIGS. 1 to 5 depict an example docking system 100 operable to secure a mobile device 25 to a display mount 50 in accordance with the teachings herein. In various embodiments, the docking system 100 includes a docking base 200 and a docking adapter 400. In some embodiments, the docking system 100 further includes a case 300 that houses the mobile device 25.

In various embodiments, the mobile device 25 is a tablet, smartphone, or other suitable mobile electronic device. The mobile device 25 can include an Android-based device, iOS-based device, Fire OS-based device, ChromeOS-based device, and/or other suitable mobile device. In some embodiments, the mobile device 25 includes a tablet or other mobile electronic device that employs a POS operating system and/or POS application.

The mobile device 25 includes a display screen 26, user input devices 27 (e.g., buttons, switches, sliders, and/or keys), and one or more communication ports 28. The communication port 28 can include a data and charging port, such as a Universal Serial Bus port, Lightning port, or other suitable port. In various embodiments, the mobile device 25 can include speakers, microphones, SIM card trays, memory card trays, and/or other suitable components.

The display mount 50 is configured to support a display device, such as a monitor (e.g., LCD), all-in-one computer, television, fixed POS device, or other suitable device. In various embodiments, the display mount 50 includes a base 52, an arm 54 that extends from the base 52, and a display mount interface 56 at the end of the arm 54. In the embodiment shown, the base 52 is placed on a counter or desk and the arm 54 extends vertically from the base 52. In other embodiments, the base 52 can be secured to a wall, ceiling, or other suitable surface. The arm 54 and display mount interface 56 are configured to support the display device at a suitable location and orientation for a user, such as in front of a clerk at a checkout counter of a store.

The display mount interface 56 includes four or more mounting holes configured to receive a fastener, such as a screw, to secure the display device. In some embodiments, the mounting holes of the display mount interface 56 are threaded to receive a screw. In other embodiments, the mounting holes of the display mount interface 56 are not threaded and a fastener passes through the mounting holes to engage a nut or other threaded element and secure the display device.

The docking base 200 includes a base body 210, a mounting post 220, base electrical contacts 230, a base magnetic securement device 240, and electrical wires 250. The base body 210 includes a housing that supports various components of the docking base 200, such as electrical components (e.g., power adapters, communication controllers and/or circuits), mechanical components (e.g., actuator components), or other suitable components. In various embodiments, the base body 210 includes one or more data ports (e.g., USB ports) and/or electrical power ports.

The docking base 200 is operable to be secured to the display mount interface 56 of the display mount 50. In various embodiments, to secure the docking base 200 to the display mount interface 56 of the display mount 50, the base body 210 includes a base bracket 212 having two or more fastener holes 214 that enable the docking base 200 to be secured to the display mount 50. In the embodiment shown in the figures, the base bracket 212 is located on a rear face of the base body 210. In other embodiments, the base bracket 212 is located on one or more sides of the base body 210. Although the base bracket 212 of the example embodiment is shown as a single bracket, the base bracket 212 includes two, three, or more bracket portions in other embodiments.

In some embodiments, the fastener holes 214 of the base bracket 212 are threaded to receive a screw or other threaded fastener. In other embodiments, the fastener holes 214 are not threaded and a suitable fastener passes through the fastener holes 214 holes to engage a nut or other thread retention device and secure the docking base 200. In other embodiments, the fastener holes 214 are configured to receive a different fastening device, such as a push clip retainer, snap-fit connector, or other suitable fastening device.

In various embodiments, the base bracket 212 is compatible with one or more standardized mounting brackets and/or proprietary mounting brackets. Specifically, the fastener holes 214 of the base bracket 212 are aligned to be compatible with the display mount interface 56 of the display mount 50. In various embodiments, the base bracket 212 is adjustable to be compatible with other brackets or other mounting holes of the display mount interface 56.

In the embodiment shown in the figures, the base bracket 212 and the display mount interface 56 are each compatible with the flat display mounting interface (FDMI) or the Video Electronics Standards Association (VESA) mounting interface standard (“VESA mount”). In this example embodiment, the display mount interface 56 and the base bracket 212 are each compatible with a VESA MIS-D 100 mm mount, which includes four screw holes with a 100 millimeter by 100 millimeter pattern size. In some embodiments, the base bracket 212 is compatible with other suitable VESA configurations having different hole patterns (e.g., 75x75, 50x100, etc.), different mounting configurations (e.g., center mount and/or edge mount), or other variations.

The mounting post 220 extends from a front surface of the base body 210 and provides a structure onto which the docking adapter 400 can be mounted. Specifically, a mounting recess 420 of the docking adapter 400 is mounted onto the mounting post 220, as described below. In the embodiment shown in the figures, the mounting post 220 is generally square-shaped, which enables the docking adapter 400 to be mounted in four different orientations for the mobile device 25 (i.e., landscape left, portrait, landscape right, and inverted portrait). In other embodiments, the mounting post 220 has a different shape, such as a hexagon, octagon, circle, or other suitable shape.

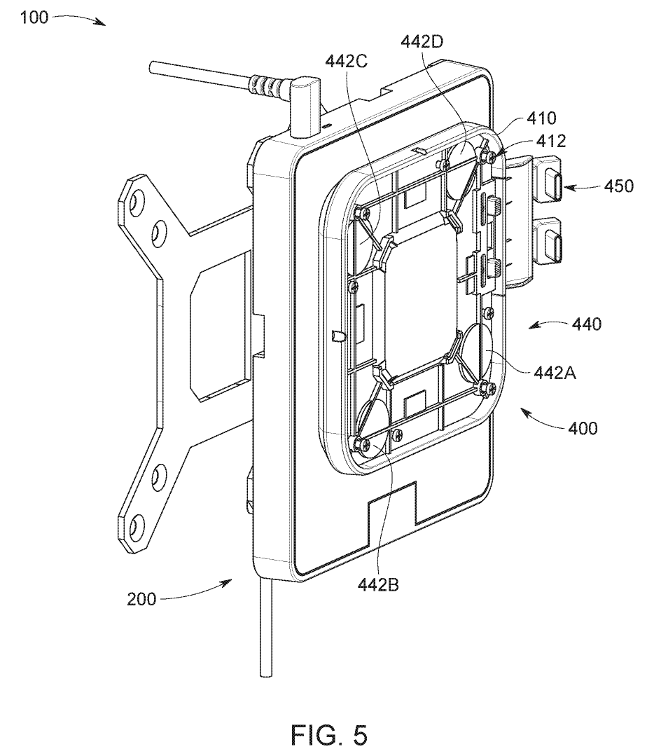

In some embodiments, to facilitate placement of the mounting recess 420 onto the mounting post 220, the mounting post 220 includes a chamfered edge, fillet edge (i.e., with a curved profile), and/or beveled edge around an outer perimeter 226 of a distal end of the mounting post 220. In the embodiment shown in FIG. 4, the mounting post 220 includes a chamfered edge around the outer perimeter 226 of the distal end. In some embodiments, the mounting post 220 includes a chamfered edge, fillet edge, and/or beveled edge around perimeter corners 228 of the mounting post 220. In the embodiment shown in FIG. 4, the mounting post 220 includes a chamfered edge around the outer perimeter of the square shape of the mounting post 220.

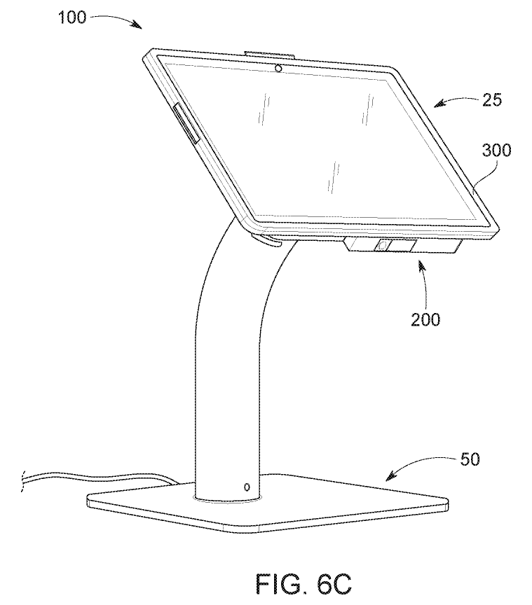

In various embodiments, the mounting post 220 is located at a post offset location of the docking base 200. In some embodiments, the docking base 200 is configured such that the mounting post 220 is offset in a first direction relative to a center of the display mount interface 56. In some such embodiments, the docking adapter 400 can be secured to the case 300 (or mobile device 25) offset to one side of the mobile device 25 (e.g., offset in a second, opposite direction) such that the mobile device 25 will be centered relative to the center of the display mount interface 56. With the docking adapter 400 offset to the one side, the docking adapter 400 enables additional space on the other side of the case 300 (i.e., opposite to the docking adapter 400) to be utilized for other purposes. In the example embodiment shown in FIG. 6A, the case 300 includes a retention device 310 on the other side. In such embodiments, the mobile device 25 can be comfortably and securely supported by a user’s hand using the retention device 310 in the offset position and also secured to the docking base 200 in a centered position relative to the display mount interface 56. In some embodiments, the mounting post 220 is offset such that the user’s hand is not pinched between the case 300 and the docking base 200 when securing the mobile device 25 to the docking base 200.

In some embodiments, the case 300 is oblong in shape, having two short sides and two long sides. In some such embodiments, the docking adapter 400 is operable to be secured offset towards a first short side of the case 300 such that the case is centered about the display mount interface 56 when the mobile device 25 is retained in the case 300, the case 300 is secured to the docking adapter 400, and the docking adapter 400 is secured to the docking base 200 with the mobile device 25 in a landscape orientation. In such embodiments, the retention device 310 is mounted towards a second short side of the case 300.

The base electrical contacts 230 are configured to facilitate data transfer and/or electrical power transfer to the mobile device 25. In various embodiments, the base electrical contacts 230 are configured to engage adapter electrical contacts 430 of the docking adapter 400, which provides a further electrical connection to the mobile device 25. In various examples, the base electrical contacts are configured to engage electrical contacts of the mobile device 25 itself.

The base magnetic securement device 240 is configured to secure the mobile device 25 to the docking base 200 with a quick-release mechanism. In the example shown in the figures, the base magnetic securement device 240 is configured to magnetically secure the docking adapter 400 to the docking base 200 while still enabling a quick-release unmounting of the mobile device 25. The base magnetic securement device 240 employs a magnetic attraction to an adapter magnetic securement device 440, described below, to secure the mobile device 25. To provide a suitable magnetic attraction, one of the base magnetic securement device 240 and the adapter magnetic securement device 440 includes a magnet, while the other of the base magnetic securement device 240 and the adapter magnetic securement device 440 includes another magnet or other suitable magnetic material (i.e., ferrous metal). In various embodiments, the base magnetic securement device 240 acts to maintain a connection between the base electrical contacts 230 and the adapter electrical contacts 430, even if the mobile device 25 is accidentally bumped by a user.

The electrical wires 250 are configured to provide data transfer and/or electrical power transfer for the docking system 200. In various embodiments, the electrical wires 250 include a power cord, USB cable, Ethernet cable, audio cable, and/or other suitable wires or cables. Although the electrical wires 250 are shown as a single cable in the example embodiment, the electrical wires 250 can include two, three, or more separate cables in other embodiments. In various embodiments, the electrical wires 250 are electrically connected to the base electrical contacts 230 and/or other electrical components supported by the base body 210. In the example embodiment, the electrical wires 250 are connected to the docking base 200 at one end, routed through a center channel of the arm 54, and connected to a power supply and/or electronic device (not shown) at an other end of the electrical wires 250.

In various embodiments, the docking base 200 includes one or more retractable tabs configured to lock the docking adapter 400, the case 300, and/or the mobile device 25 to the docking base 200, for example, to prevent accidental removal of the mobile device 25 and/or theft of the mobile device 25. The retractable tabs are movable between an extended position in which the docking adapter 400 is secured to the docking base 200 and a retracted position in which the docking adapter 400 is releasable from the docking base 200. In the embodiment shown in the figures, the mounting post 220 includes four retractable tabs 222 that extend radially outward from a center axis of the mounting post 220.

In various embodiments, the docking base 200 includes a tab actuator, such as a lever, switch, electro-mechanical actuator, or other suitable actuator, that selectively causes the retractable tabs 222 to extend outward to lock the mobile device 25 and/or retract inward to release (or enable the release of) the mobile device 25. In the example embodiment shown in the figures, the docking base 200 includes a tab actuator 224 that is slidable by a user to actuate the retractable tabs between the extended position and the retracted position. In some embodiments, the tab actuator 224 is positioned in a location that is concealed when the mobile device 25 is docked to the docking base 200 to prevent unauthorized release of the mobile device 25.

In some embodiments, the retractable tabs 222 are spring-loaded and biased towards the retracted position and actuation of the tab actuator causes the retractable tabs 222 to extend outward. In some embodiments, the retractable tabs 222 are spring-loaded and biased towards an extended position. In some such embodiments, the mounting recess 420 is configured to: (1) push the retractable tabs 222 inward when securing the docking adapter 400 to the docking base 200 to prevent interference with mounting the docking adapter 400; and (2) release the retractable tabs 222 outward once the docking adapter 400 is suitably mounted onto the mounting post 220.

In various embodiments, the docking base 200 includes a wireless charging device 260 that enables a wireless charging feature of the mobile device 25 when the mobile device 25 is docked in the docking base 200. In various embodiments, the wireless charging device 260 includes a charging controller (e.g., a processor and driver circuit) and an inductive coil that are configured to provide a suitable magnetic field to a corresponding inductive coil and charging controller of the mobile device 25 when the mobile device 25 is secured to the docking base 200. In the embodiment shown in the figures, the inductive coil of the wireless charging device 260 is located within the mounting post 220 to provide a suitable proximity between the inductive coils of the wireless charging device 260 and the mobile device 25. In some embodiments, the wireless charging device 260 includes an inductive coil located within the base body 210.

The case 300 is configured to securely house the mobile device 25. In the example embodiment shown, the case 300 is a one piece body, but can include two, three, or more pieces in other embodiments. In various embodiments, the case 300 includes polycarbonate, polyoxymethylene, other suitable thermoplastics, carbon fiber reinforced polymer (“carbon fiber”), other fiber reinforced polymers (e.g., fiberglass reinforced nylon), thermoplastic polyurethane (TPU), silicone, and/or other suitable materials.

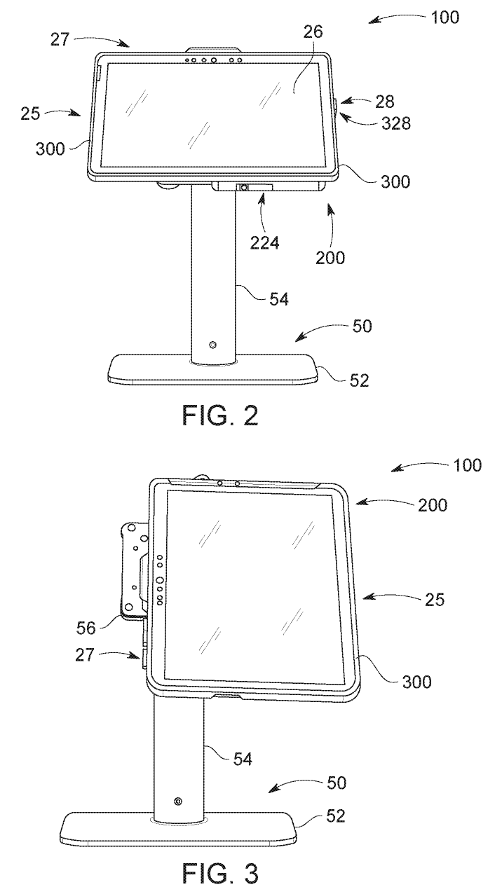

In some embodiments, the case 300 is an oblong case having two short sides and two long sides. In the example embodiment shown in FIG. 2, the two short sides are left and right sides and the two long sides are top and bottom sides. The case 300 includes a back wall and a plurality of a side walls. A front side of the back wall and the side walls define a cavity or opening in which the mobile device 25 is secured. In various embodiments, the case 300 includes a communication port hole 328 for the communication port 28 of the mobile device 25. In various embodiments, the case 300 defines one or more additional holes (not labeled) to facilitate user interaction with one or more components of the mobile device 25, such as buttons, switches, speakers, microphones, SIM card trays, memory card trays, or other suitable components of the mobile device 25. In some embodiments, the additional holes include mounting holes configured to receive a fastener to secure the case 300 to the docking adapter 400. In certain embodiments, the case 300 includes a magnetic securement device, for example, to facilitate wireless charging and/or accessory attachments for the mobile device 25.

In various embodiments, the case 300 includes one or more structural features, fasteners, and/or connectors that secure the mobile device 25 within the opening of the case 300, for example, to promote retention of the mobile device 25 within the case 300 during forceful motions (e.g., a physical impact). In various embodiments, the case 300 includes an inner lip that extends around an inner perimeter of the side walls along an outer edge of the mobile device 25 and extends partially over a front face (i.e., a screen) of the mobile device 25. Other configurations of the inner lip and other means to secure the mobile device 25 within the case 300 are contemplated and within the scope of the present disclosure.

To secure the docking adapter 400 to the case 300, the case 300 includes one or more fastening devices (not shown). In the example embodiment shown in the figures, the fastening devices of the case 300 include mounting holes through which screws pass through and into corresponding fastening devices 412 (described below) of the docking adapter 400. In various embodiments, the fastening devices include mounting holes, threaded recesses or posts, push clip retainers, snap-fit connectors, or other suitable fastening devices.

In various embodiments, the case 300 includes multiple fastening device groups (not shown). Each fastening device group includes one or more fastening devices that enable different components to be secured to the case 300. The different components can include the docking adapter 400, the retention device 310, an external battery, a barcode scanner, a case stand (i.e., for propping up the mobile device 25 when placed on a surface or user’s lap), other case accessories, or other suitable components. In the example embodiment shown in FIG. 6A, the case 300 includes a first fastening device group that secures the retention device 310 to the case 300 and a second fastening device group that secures the docking adapter 400 to the case 300.

In various embodiments, the case 300 includes a retention device 310 that facilitates supporting the case 300 by a user’s hand. In some embodiments, the retention device 310 secures the case 300 to the user’s hand. In the embodiment shown in FIG. 6A, the retention device 310 includes a hand strap configured to wrap around a back of a user’s hand. In other embodiments, the retention device 310 includes a clip that fits over the user’s hand or other suitable retention device. In various embodiments, the retention device 310 enables a user to hold the case 300 with their hand, but without wrapping a thumb or finger(s) around an edge of the case 300, which may cause inadvertent user inputs on a touch screen display of the mobile device 25.

In some embodiments, the case 300 includes a magnetic securement device (not shown) configured to secure the mobile device 25 to the docking base 200. Specifically, the magnetic securement device of the case 300 is configured to magnetically secure the case 300 to the docking base 200. To provide a suitable magnetic attraction, one of the base magnetic securement device 240 and the magnetic securement device of the case 300 includes a magnet, while the other includes another magnet or other suitable magnetic material (i.e., ferrous metal). In some such embodiments, the magnetic securement device of the case 300 and the adapter magnetic securement device 440 cooperate to magnetically secure the mobile device 25 to the docking base 200.

The docking adapter 400 includes an adapter body 410, the mounting recess 420, the adapter electrical contacts 430, the adapter magnetic securement device 440, and a communication plug 450. The adapter body 410 includes a housing that supports various components of the docking adapter 400, such as electrical components (e.g., power adapters, communication controllers and/or circuits) or other suitable components.

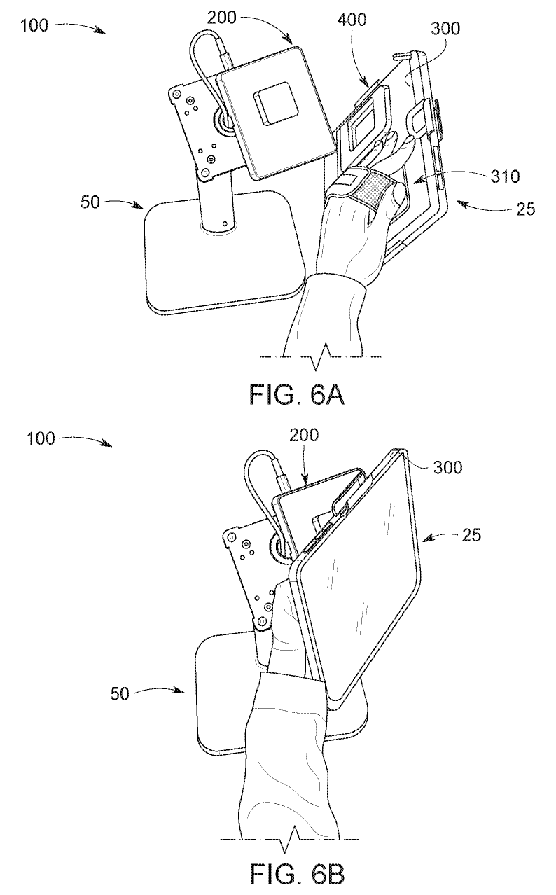

To secure the docking adapter 400 to the case 300, the adapter body 410 includes one or more fastening devices 412. In the example embodiment shown in FIG. 5, the fastening devices 412 include threaded recesses into which screws pass through corresponding mounting holes of the case 300. In some embodiments, the fastening devices 412 include push clip retainers, snap-fit connectors, or other suitable fastening devices. In some embodiments, the fastening devices 412 include threaded posts that pass through the corresponding mounting hole of the case 300 and receive a nut or other thread retention device.

The mounting recess 420 extends into the adapter body 410 and is configured to receive the mounting post 220 of the docking base 200. In other words, the mounting recess 420 is mounted onto the mounting post 220 to removably secure the docking adapter 400 onto the docking base 200. In the example embodiment shown in the figures, the mounting recess 420 is generally square-shaped. In some embodiments, the mounting post 410 and the mounting post 420 have different shapes that enable additional orientations when secured to one another, such as a square-shaped mounting post and an octagon-shaped mounting recess that enables orientations at 0°, 45°, 90°, 135°, etc.

In various embodiments, the mounting recess 420 includes an outer perimeter 426 having a chamfered edge, fillet edge, and/or beveled edge to facilitate placement of the mounting recess 420 onto the mounting post 220. In some embodiments, the mounting recess 420 includes perimeter corners 428 having a chamfered edge, fillet edge, and/or beveled edge. In the embodiment shown in FIG. 4, the mounting recess 420 includes a chamfered edge around the outer perimeter 426 and a chamfered edge around the perimeter corners 428.

The adapter electrical contacts 430 are configured to facilitate data transfer and/or electrical power transfer to the mobile device 25. The adapter electrical contacts 430 are configured such that if the docking base 200 and the docking adapter 400 are connected to one another, the base electrical contacts 230 are connected to the adapter electrical contacts 430. Once connected, the docking system 100 is enabled to provide electrical power and/or data transfer between the mobile device 25 and the electrical wires 250 via the docking adapter 400 and the docking base 200.

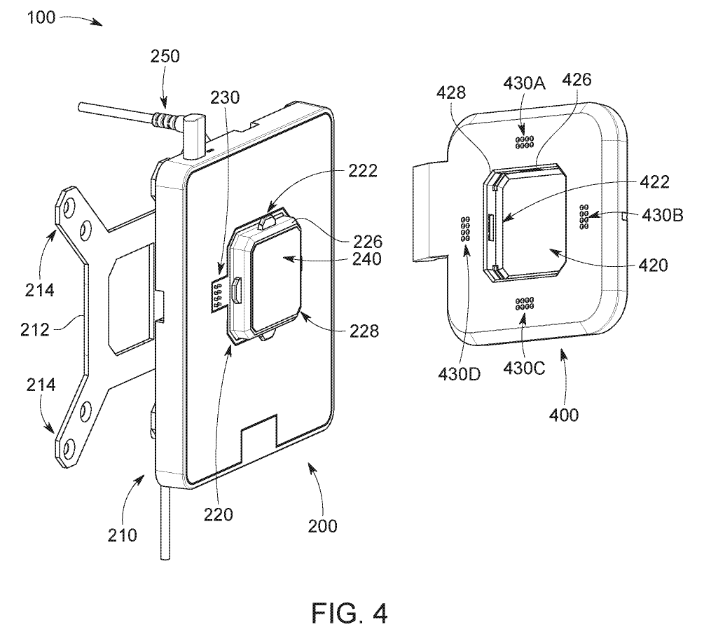

In the embodiment shown in the figures, the adapter electrical contacts 430 are implemented in redundant groups shown as groups 430A, 430B, 430C, and 430D such that one group of the adapter electrical contacts 430 is connected with the base electrical contacts 230 when the docking base 200 and the docking adapter 400 are connected to one another. For example, the group 430A is configured to connect with the base electrical contacts 230 when the mobile device 25 is in a portrait orientation (as shown in FIG. 3), the group 430B is configured to connect with the base electrical contacts 230 when the mobile device 25 is in a landscape orientation (as shown in FIG. 2), and so on.

The adapter magnetic securement device 440 is configured to secure the mobile device 25 to the docking base 200. In the example shown in the figures, the adapter magnetic securement device 240 is configured to magnetically secure the docking adapter 400 to the docking base 200 via a magnetic attraction to the base magnetic securement device 240. As described above, one of the base magnetic securement device 240 and the adapter magnetic securement device 440 includes a magnet, while the other of the base magnetic securement device 240 and the adapter magnetic securement device 440 includes another magnet or other suitable magnetic material (i.e., ferrous metal). In various embodiments, the adapter magnetic securement device 440 acts to maintain a connection between the base electrical contacts 230 and the adapter electrical contacts 430. In the example embodiment shown in FIG. 5, the adapter magnetic securement device 440 includes four magnets 442A, 442B, 442C, and 442D that are securable to corresponding magnets (not shown) of the base magnetic securement device 240.

The communication plug 450 is configured to provide an electrical connection between the communication port 28 of the mobile device 25 and the adapter electrical contacts 430. In various embodiments, the communication plug 450 provides an electrical connection between the communication port 28 and other electrical components of the docking adapter 400. In the example embodiment shown in FIG. 5, the communication plug 450 includes a USB-C plug that can be inserted directly into the communication port 28 of the mobile device 25. In some embodiments, the docking adapter 400 includes multiple communication ports (not shown) at different locations of the docking adapter 400, for example, at different locations around a perimeter of the adapter body 410. In such embodiments, the communication plug 450 is removable to be swapped between the different communication ports, enabling the same docking adapter 400 to be more readily employed with different mobile devices that have their communication ports in different locations.

Turning to FIGS. 6A, 6B, and 6C, an example sequence of mounting the mobile device 25 to the display mount 50 using the docking system 100 is shown. For this example sequence: (1) the docking base 200 is secured to the display mount 50 by the base bracket 212; (2) the docking adapter 400 is secured to the case 300; and (3) the mobile device 25 is secured within the case 300.

As shown in FIG. 6A, a user employs the retention device 310 to support the mobile device 25 with their hand. As the user approaches the display mount 50, the user aligns the case 300 such that the mounting recess 420 is aligned with the mounting post 220, as shown in FIG. 6B. In this example sequence, the user aligns the case 300 in a landscape orientation. As the mounting recess 420 is placed onto a distal end of the mounting post 220, the base magnetic securement device 240 and the adapter magnetic securement device 440 provide an increased level of magnetic attraction to secure the case 300 to the docking base 200. Once the mounting recess 420 is seated on the mounting post 220 as shown in FIG. 6C, the base electrical contacts 230 engage the adapter electrical contacts 430 to enable data and/or electrical power transfer to the mobile device 25 and the wireless charging device 260 enables wireless charging for the mobile device 25.

In some embodiments, the adapter body 410 configured to separate a front face of the display mount interface 56 from a rear face of the case 300 to accommodate a user’s hand when the mobile device 25 is retained in the case 300, the case is secured to the docking adapter 400, and the docking adapter 400 is secured to the docking base 200.

Although only a single example case 300 and mobile device 25 are shown in the example embodiment, other variations of the case 300 and mobile device 25 are contemplated and within the scope of the present disclosure. In various embodiments, the docking adapter 400 is configured to be coupled with any of a plurality of different cases, for example, as a modular accessory to the different cases. In some such embodiments, the docking system 100 provides a modular solution to mounting different mobile devices on existing display mounts. In some embodiments, the docking system 100 enables a store operator or warehouse operator to employ the same docking system 100 at each of a plurality of different locations, even if a different mobile device is used at each location. In other words, the store or warehouse operator can employ their own mobile devices, or even change mobile devices while using the same docking system 100, instead of being restricted to a particular POS system or terminal.

Although only a single example display mount 50 is shown in the example embodiment, other variations of the display mount 50 are contemplated and within the scope of the present disclosure. In embodiments in which the base bracket 212 of the docking base 200 is compatible with a VESA mount, the docking base 200 is enabled to be mounted to many different display mounts that provide a VESA mount. Advantageously, the docking base 200 enables a retail store having several existing display mounts of different styles, types, and/or configurations, but that are each compatible with a VESA mount, to purchase multiple instances of the docking base 200 instead of different docking bases for each variation of display mount. In some embodiments, the docking base 200 includes one or more intermediate accessory brackets (not shown) such that the base bracket 212 is securable to the intermediate accessory bracket, which is in turn securable to a display mount.

It should be appreciated that the docking base 200, the case 300, and the docking adapter 400 can vary in accordance with the present disclosure. For example, the docking base 200 and docking adapter 400 can employ different sizes and shapes of the mounting post 220 and mounting recess 420 that facilitate attachment of the docking adapter 400 to the docking base 200.

Exemplary embodiments in accordance with the teachings herein are disclosed below.

An example docking system includes a docking base operable to be secured to a display mount interface of a display mount, the docking base comprising a mounting post at a post offset location of the docking base, and a docking adapter operable to be secured to the mobile device at a device offset location of the mobile device, the docking adapter comprising a mounting recess operable to receive the mounting post to removably secure the docking adapter to the docking base. The device offset location is offset from a center of the mobile device, and the post offset location is offset from a center of the display mount interface such that the mobile device is centered about the display mount interface when the mobile device is secured to the docking adapter and the docking adapter is secured to the docking base.

In some examples, the display mount interface comprises a Video Electronics Standards Association (VESA) mount interface; and the docking base comprises a base bracket having fastener holes arranged in a VESA mount interface pattern.

In some examples, the mobile device is centered about the display mount interface when the mobile device is secured to the docking adapter and the docking adapter is secured to the docking base in a landscape orientation of the mobile device.

In some examples, the docking adapter is securable to the docking post in a portrait orientation of the mobile device.

In some examples, the mobile device is centered about the display mount interface when the mobile device is secured to the docking adapter and the docking adapter is secured to the docking base in a portrait orientation of the mobile device.

In some examples, the docking adapter is securable to the docking post in a landscape orientation of the mobile device.

In some examples, the docking adapter is operable to be secured to the mobile device on a first side of the docking adapter and the mounting recess is located on a second side of the docking adapter, opposite to the first side.

In some examples, the docking base comprises a base magnetic securement device; the docking adapter comprises an adapter magnetic securement device; and the base magnetic securement device and the adapter magnetic securement device magnetically secure the mobile device to the docking base when the mobile device is secured to the docking adapter and the docking adapter is secured to the docking base.

In some examples, the docking system further comprises a case having mounting holes and configured to securely house the mobile device; and the docking adapter comprises one or more fastening devices configured to secure the case to the docking adapter via the mounting holes.

In some examples, the case further comprises a retention device operable to secure the case to a user’s hand; the device offset location is offset from the center of the mobile device in a first direction; the retention device is offset from the center of the mobile device in a second direction opposite the first direction.

In some examples, the docking adapter comprises an adapter body configured to separate a front face of the display mount interface from a rear face of the case to accommodate a user’s hand when the mobile device is retained in the case, the case is secured to the docking adapter, and the docking adapter is secured to the docking base.

In some examples, the docking adapter is operable to be secured to any of a plurality of cases, each case having mounting holes and being configured to securely house a different mobile device, the docking adapter having one or more fastening devices configured to secure that case to the docking adapter via the mounting holes of that case.

In some examples, the docking adapter comprises an adapter body configured to separate a front face of the display mount interface from a rear face of the mobile device to accommodate a user’s hand when the mobile device is secured to the docking adapter and the docking adapter is secured to the docking base.

An example docking system includes: a docking base operable to be secured to a display mount interface of a display mount, the docking base comprising a mounting post that is offset from a center of the display mount interface when the docking base is secured to the display mount interface; a docking adapter operable to be secured to an oblong case that retains the mobile device, the docking adapter comprising a mounting recess operable to receive the mounting post to removably secure the docking adapter to the docking base; the docking adapter is operable to be secured offset towards a first short side of the oblong case such that the oblong case is centered about the display mount interface when the mobile device is retained in the oblong case, the oblong case is secured to the docking adapter, and the docking adapter is secured to the docking base with the mobile device in a landscape orientation.

In some examples, the display mount interface comprises a Video Electronics Standards Association (VESA) mount interface; and the docking base comprises a base bracket having fastener holes arranged in a VESA mount interface pattern.

In some examples, the docking adapter is operable to be selectively secured to the mounting post with the mobile device in the landscape orientation and in a portrait orientation.

In some examples, the docking base comprises a base magnetic securement device; the docking adapter comprises an adapter magnetic securement device; and the base magnetic securement device and the adapter magnetic securement device are magnetically secured to each other when the mounting post is secured to the mounting recess.

In some examples, the docking system further comprises the oblong case; the oblong case comprises a hand retention device that is secured offset towards a second short side of the oblong case.

In some examples, the docking adapter comprises an adapter body configured to separate a front face of the display mount interface from a rear face of the oblong case to accommodate a user’s hand when the mobile device is retained in the oblong case, the oblong case is secured to the docking adapter, and the docking adapter is secured to the docking base.

In some examples, the hand retention device is a hand strap that secures the rear face of the oblong case to the user’s hand.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A docking system for a mobile device, comprising:
a docking base operable to be secured to a display mount interface of a display mount, the docking base comprising a mounting post at a post offset location of the docking base;
a docking adapter operable to be secured to the mobile device at a device offset location of the mobile device, the docking adapter comprising a mounting recess operable to receive the mounting post to removably secure the docking adapter to the docking base;
wherein:
the device offset location is offset from a center of the mobile device, and
the post offset location is offset from a center of the display mount interface such that the mobile device is centered about the display mount interface when the mobile device is secured to the docking adapter and the docking adapter is secured to the docking base.

2. The docking system for the mobile device of claim 1, wherein:
the display mount interface comprises a Video Electronics Standards Association (VESA) mount interface; and
the docking base comprises a base bracket having fastener holes arranged in a VESA mount interface pattern.

3. The docking system for the mobile device of claim 1, wherein the mobile device is centered about the display mount interface when the mobile device is secured to the docking adapter and the docking adapter is secured to the docking base in a landscape orientation of the mobile device.

4. The docking system for the mobile device of claim 3, wherein the docking adapter is securable to the docking post in a portrait orientation of the mobile device.

5. The docking system for the mobile device of claim 1, wherein the mobile device is centered about the display mount interface when the mobile device is secured to the docking adapter and the docking adapter is secured to the docking base in a portrait orientation of the mobile device.

6. The docking system for the mobile device of claim 5, wherein the docking adapter is securable to the docking post in a landscape orientation of the mobile device.

7. The docking system for the mobile device of claim 1, wherein the docking adapter is operable to be secured to the mobile device on a first side of the docking adapter and the mounting recess is located on a second side of the docking adapter, opposite to the first side.

8. The docking system for the mobile device of claim 1, wherein:
the docking base comprises a base magnetic securement device;
the docking adapter comprises an adapter magnetic securement device; and
the base magnetic securement device and the adapter magnetic securement device magnetically secure the mobile device to the docking base when the mobile device is secured to the docking adapter and the docking adapter is secured to the docking base.

9. The docking system for the mobile device of claim 1, wherein:
the docking system further comprises a case having mounting holes and configured to securely house the mobile device; and
the docking adapter comprises one or more fastening devices configured to secure the case to the docking adapter via the mounting holes.

10. The docking system for the mobile device of claim 9, wherein:
the case further comprises a retention device operable to secure the case to a user’s hand;
the device offset location is offset from the center of the mobile device in a first direction; and
the retention device is offset from the center of the mobile device in a second direction opposite the first direction.

11. The docking system for the mobile device of claim 9, wherein the docking adapter comprises an adapter body configured to separate a front face of the display mount interface from a rear face of the case to accommodate a user’s hand when the mobile device is retained in the case, the case is secured to the docking adapter, and the docking adapter is secured to the docking base.

12. The docking system for the mobile device of claim 1, wherein:
the docking adapter is operable to be secured to any of a plurality of cases, each case having mounting holes and being configured to securely house a different mobile device, the docking adapter having one or more fastening devices configured to secure that case to the docking adapter via the mounting holes of that case.

13. The docking system for the mobile device of claim 1, wherein the docking adapter comprises an adapter body configured to separate a front face of the display mount interface from a rear face of the mobile device to accommodate a user’s hand when the mobile device is secured to the docking adapter and the docking adapter is secured to the docking base.

14. A docking system for a mobile device, comprising:
a docking base operable to be secured to a display mount interface of a display mount, the docking base comprising a mounting post that is offset from a center of the display mount interface when the docking base is secured to the display mount interface; and
a docking adapter operable to be secured to an oblong case that retains the mobile device, the docking adapter comprising a mounting recess operable to receive the mounting post to removably secure the docking adapter to the docking base;
wherein:
the docking adapter is operable to be secured offset towards a first short side of the oblong case such that the oblong case is centered about the display mount interface when the mobile device is retained in the oblong case, the oblong case is secured to the docking adapter, and the docking adapter is secured to the docking base with the mobile device in a landscape orientation.

15. The docking system of claim 14, wherein:
the display mount interface comprises a Video Electronics Standards Association (VESA) mount interface; and
the docking base comprises a base bracket having fastener holes arranged in a VESA mount interface pattern.

16. The docking system of claim 15, wherein the docking adapter is operable to be selectively secured to the mounting post with the mobile device in the landscape orientation and in a portrait orientation.

17. The docking system of claim 16, wherein:
the docking base comprises a base magnetic securement device;
the docking adapter comprises an adapter magnetic securement device; and
the base magnetic securement device and the adapter magnetic securement device are magnetically secured to each other when the mounting post is secured to the mounting recess.

18. The docking system of claim 17, wherein:
the docking system further comprises the oblong case; and
the oblong case comprises a hand retention device that is secured offset towards a second short side of the oblong case.

19. The docking system of claim 18, wherein the docking adapter comprises an adapter body configured to separate a front face of the display mount interface from a rear face of the oblong case to accommodate a user’s hand when the mobile device is retained in the oblong case, the oblong case is secured to the docking adapter, and the docking adapter is secured to the docking base.

20. The docking system of claim 19, wherein the hand retention device is a hand strap that secures the rear face of the oblong case to the user’s hand.
